(19) United States
(12) Patent Application Publication
(10) Pub. No.: US 2026/0134401 A1
(43) Pub. Date: May 14, 2026

(54) MACHINE LEARNING BASED SYSTEM AND METHOD FOR AUTOMATICALLY CATEGORIZING ELECTRIONIC DOCUMENTS IN ELECTRONIC MAILS

(71) Applicant: HIGHRADIUS CORPORATION, Houston, TX (US)

(72) Inventors: Debanwesh Bose, Hyderabad (IN); Srajan Agarwal, Hyderabad (IN); Sumit Gupta, Hyderabad (IN); Vipul Jain, Hyderabad (IN); Ansumun Gouda, Hyderabad (IN); Lohit Vankina, Hyderabad (IN); Hashwanth Maripina, Hyderabad (IN); Aishwarya Kumar, Hyderabad (IN)

(21) Appl. No.: 18/942,815

(22) Filed: Nov. 11, 2024

(51) Int. Cl. G06Q 10/107; G06V 30/19

(52) U.S. Cl. CPC G06Q 10/107; G06V 30/19173

(57) ABSTRACT

A machine learning based (ML-based) computing method and system for automatically categorizing electronic documents in electronic mails, is disclosed. Initially, data associated with the electronic documents are obtained from databases. The data are pre-processed to generate pre-processed texts. The pre-processed texts associated with the electronic documents are analyzed to classify the pre-processed texts into one of a finance related content and a non-finance related content, using a ML model. The electronic documents are categorized as one of electronic financial documents when the pre-processed texts are classified as finance related content, and electronic non-financial documents when the pre-processed texts are classified as non-finance related content, using the ML model. The categorized electronic non-financial documents are re-categorized into electronic financial documents using rule-based classification technique to mitigate false negative categorization of electronic documents as the electronic non-financial documents. The categorized electronic financial documents are provided as an output to users.

### FIELD OF INVENTION

Embodiments of the present disclosure relate to machine learning based (ML-based) computing systems, and more particularly relates to a ML-based computing method and system for categorizing one or more electronic documents in one or more electronic mails.

### BACKGROUND

In today's financial management, finance teams face a complex task of analyzing numerous documents received through email, which presents a significant challenge in distinguishing between remittance and non-remittance documents. This distinction is vital for proper handling of financial transactions and ensuring the accuracy of financial records. The wide range of these documents, which may include invoices, payment confirmations, and general communications, adds to the difficulty of classification and processing. Efficient and precise categorization of these documents is crucial for smooth operation of finance departments and has far-reaching effects on financial reporting, regulatory compliance, and overall speed of transactions in the digital era.

At present, the most common method for handling large volume of financial documents involves manual processing by extensive finance teams. This method usually entails team members carefully examining each document received through email, identifying each document as either a remittance or non-remittance document, and processing each document accordingly. To assist with this task, some finance teams utilize general-purpose document parsing tools and Optical Character Recognition (OCR) systems. These technologies are developed to automatically detect and extract text from digital document images, streamlining the classification and processing of the documents.

However, even with a support of general-purpose parsing software and OCR systems, the manual approach is still burdened with several drawbacks. The manual approach is inherently slow, costly, and vulnerable to human error, which may result in misclassification of documents and inaccuracies in financial records. Additionally, because current document parsing and OCR technologies are not specifically designed for the unique characteristics of financial documents, they often lack the precision and speed required for effective processing. These systems frequently struggle to accurately distinguish between remittance and non-remittance documents, leading to further inefficiencies and a higher risk of financial errors.

Hence, there is a need for an improved machine learning based (ML-based) computing system and method for categorizing one or more electronic documents in one or more electronic mails, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a machine-learning based (ML-based) computing method for automatically categorizing one or more electronic documents in one or more electronic mails, is disclosed. The ML-based computing method comprises obtaining, by one or more hardware processors, data associated with the one or more electronic documents from one or more databases.

The ML-based computing method further comprises pre-processing, by the one or more hardware processors, the data associated with the one or more electronic documents to generate one or more pre-processed texts

The ML-based computing method further comprises analyzing, by the one or more hardware processors, the one or more pre-processed texts associated with the one or more electronic documents to classify the one or more pre-processed texts into one of a finance related content and a non-finance related content, using a machine learning (ML) model.

The ML-based computing method further comprises categorizing, by the one or more hardware processors, the one or more electronic documents as one of: one or more electronic financial documents when the one or more pre-processed texts are classified as the finance related content, using the ML model, and one or more electronic non-financial documents when the one or more pre-processed texts are classified as the non-finance related content, using the ML model.

The ML-based computing method further comprises re-categorizing, by the one or more hardware processors, the categorized one or more electronic non-financial documents into the one or more electronic financial documents using a rule-based classification technique to mitigate false negative categorization of the one or more electronic documents as the one or more electronic non-financial documents.

The ML-based computing method further comprises providing, by the one or more hardware processors, the categorized one or more electronic financial documents as an output, to one or more users on one or more user interfaces associated with the one or more electronic devices associated with the one or more users.

In an embodiment, pre-processing the data associated with the one or more electronic documents comprises extracting, by the one or more hardware processors, one or more texts from one or more formats of the one or more electronic documents, using a document parser.

In another embodiment, pre-processing the data associated with the one or more electronic documents further comprises sentence processing by: (a) splitting, by the one or more hardware processors, the one or more texts into one or more words to standardize the one or more texts for the ML model, using a tokenization process; (b) reducing, by the one or more hardware processors, the one or more words to a dictionary form of the one or more words using a lemmatization technique; (c) identifying, by the one or more hardware processors, parts of speech of each of the one or more words with a predefined mapping to optimize word recognition; (d) determining and labelling, by the one or more hardware processors, one or more patterns associated with the one or more words, using a regular expression technique, wherein the one or more patterns comprise at least one of: one or more alphabets, one or more numerical sequences, one or more dates, one or more monetary values, and one or more alphanumeric identifiers, within the one or more texts; and (c) identifying, by the one or more hardware processors, potential identifiers associated with the finance related content using the one or more patterns, based on a length criteria.

In yet another embodiment, pre-processing the data associated with the one or more electronic documents further comprises filtering, by the one or more hardware processors, at least one of: one or more common language stop words, one or more non-alphabetic characters, and one or more special characters, from the one or more texts to generate the one or more pre-processed texts, based on one or more custom noise removal rules.

In yet another embodiment, re-categorizing the categorized one or more electronic non-financial documents into the one or more electronic financial documents, comprises: (a) obtaining, by the one or more hardware processors, one or more information associated with the one or more electronic non-financial documents; (b) determining, by the one or more hardware processors, the one or more false negative categorization of the one or more electronic documents as the one or more electronic non-financial documents; and (c) identifying, by the one or more hardware processors, one or more key elements associated with the one or more electronic non-financial documents to accurately re-categorize the one or more electronic non-financial documents as the one or more electronic financial documents, wherein the one or more key elements associated with the one or more electronic non-financial documents comprise data associated with at least one of: date, amount, and remittance identifier.

In yet another embodiment, analyzing the one or more pre-processed texts associated with the one or more electronic documents to classify the one or more pre-processed texts into one of the finance related content and the non-finance related content using the machine learning (ML) model comprises: (a) obtaining, by the one or more hardware processors, at least one of: one or more training datasets and one or more testing datasets, associated with the one or more electronic documents from the one or more databases; (b) converting, by the one or more hardware processors, one or more labels associated with the one or more texts in the one or more training datasets and the one or more testing datasets, into one or more numerical formats for training the ML model, using a label encoding process; (c) converting, by the one or more hardware processors, the one or more texts in the one or more training datasets and the one or more testing datasets into the one or more numerical formats for training the ML model, using term frequency-inverse document frequency (TFIDF) vectorizer; (d) selecting, by the one or more hardware processors, one or more features to represent the finance related content and the non-finance related content using the TFIDF vectorizer; (c) classifying, by the one or more hardware processors, the one or more pre-processed texts into one of the finance related content and the non-finance related content using the ML model, wherein the ML model comprises a light gradient boosting machine (LGBM) model; and (f) optimizing, by the one or more hardware processors, the LGBM model to determine one or more hyperparameters from a predefined set of options, using a grid search technique, wherein the one or more hyperparameters comprise at least one of: column sample by tree indicating proportion of columns randomly sampled for each tree, learning rate indicating a rate at which the ML-model learns, optimum depth indicating control of an optimum depth of each tree, n estimators indicating a number of boosting iterations the ML-model executes, number of leaves indicating control of complexity of each tree.

In yet another embodiment, the ML-based computing method further comprises (a) validating, by the one or more hardware processors, performance of the ML model based on the one or more testing datasets using a classification report, wherein the classification report comprises one or more metrics comprising at least one of: precision, recall, and F1-score metrics, and wherein the classification report provides an optimized level of accuracy indicating an optimized classification of the one or more electronic documents; and; and (b) adjusting, by the one or more hardware processors, the one or more hyperparameters to fine-tune the ML model based on one or more results of validation of the ML model.

In yet another embodiment, the ML-based computing method further comprises re-training, by the one or more hardware processors, the ML model. Re-training the ML model comprises: (a) obtaining, by the one or more hardware processors, one or more assessments of the ML model from the one or more users via the one or more electronic devices; (b) identifying, by the one or more hardware processors, one or more differences between performance on the categorization of the one or more electronic documents by the ML model, and the one or more assessments of the ML model obtained from the one or more users via the one or more electronic devices; (c) determining, by the one or more hardware processors, whether the ML model needs to be optimized on categorization of the one or more electronic documents as one of the one or more electronic financial documents and the one or more electronic non-financial documents, based on the identified one or more differences between the performance on the categorization of the one or more electronic documents by the ML model, and the one or more assessments of the ML model obtained from the one or more users via the one or more electronic devices associated with the one or more users; (d) re-training, by the one or more hardware processors, the ML model upon determining that the ML model needs to be optimized on categorization of the one or more electronic documents as one of the one or more electronic financial documents and the one or more electronic non-financial documents, wherein re-training the ML model comprises at least one of: updating pre-processing of the data associated with the one or more electronic documents, adjusting features selection criteria, and adjusting the one or more hyperparameters; (c) monitoring, by the one or more hardware processors, the performance of the ML model on categorization of the one or more electronic documents as one of the one or more electronic financial documents and the one or more electronic non-financial documents; (f) collecting, by the one or more hardware processors, the one or more assessments of the ML model over a plurality of time intervals; and (g) adapting, by the one or more hardware processors, the ML model to learn the one or more patterns in the data associated with the one or more electronic documents based on one or more feedback on the performance of the ML model.

In one aspect, a machine learning based (ML-based) computing system for automatically categorizing one or more electronic documents in one or more electronic mails, is disclosed. The ML-based computing system includes one or more hardware processors and a memory coupled to the one or more hardware processors. The memory includes a plurality of subsystems in the form of programmable instructions executable by the one or more hardware processors.

The plurality of subsystems comprises a document obtaining subsystem configured to obtain data associated with the one or more electronic documents from one or more databases.

The plurality of subsystems further comprises a document pre-processing subsystem configured to pre-process the data associated with the one or more electronic documents to generate one or more pre-processed texts.

The plurality of subsystems further comprises a document classifying subsystem configured to: (a) analyze the one or more pre-processed texts associated with the one or more electronic documents to classify the one or more pre-processed texts into one of a finance related content and a non-finance related content, using a machine learning (ML) model; (b) categorize the one or more electronic documents as one of one or more electronic financial documents when the one or more pre-processed texts are classified as the finance related content, using the ML model, and one or more electronic non-financial documents when the one or more pre-processed texts are classified as the non-finance related content, using the ML model; and (c) re-categorize the categorized one or more electronic non-financial documents into the one or more electronic financial documents using a rule based classification technique to mitigate false negative categorization of the one or more electronic documents as the one or more electronic non-financial documents.

The plurality of subsystems further comprises an output subsystem configured to provide the categorized one or more electronic financial documents as an output, to one or more users on one or more user interfaces associated with the one or more electronic devices associated with the one or more users.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment with a machine learning based (ML-based) computing system for categorizing one or more electronic documents in one or more electronic mails, in accordance with an embodiment of the present disclosure;

FIG. 2 is a detailed view of the ML-based computing system for categorizing the one or more electronic documents in the one or more electronic mails, in accordance with another embodiment of the present disclosure;

FIG. 3 is an overall process flow of categorizing the one or more remittance documents in the one or more electronic mails, in accordance with another embodiment of the present disclosure;

FIG. 4 is an exemplary process flow of categorizing and re-categorizing the one or more remittance documents in the one or more electronic mails, in accordance with another embodiment of the present disclosure;

FIG. 5 is an exemplary process flow of categorizing the content in the one or more electronic mails, in accordance with another embodiment of the present disclosure; and

FIG. 6 is a flow chart illustrating a machine-learning based (ML-based) computing method for categorizing the one or more remittance documents in the one or more electronic mails, in accordance with an embodiment of the present disclosure;

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

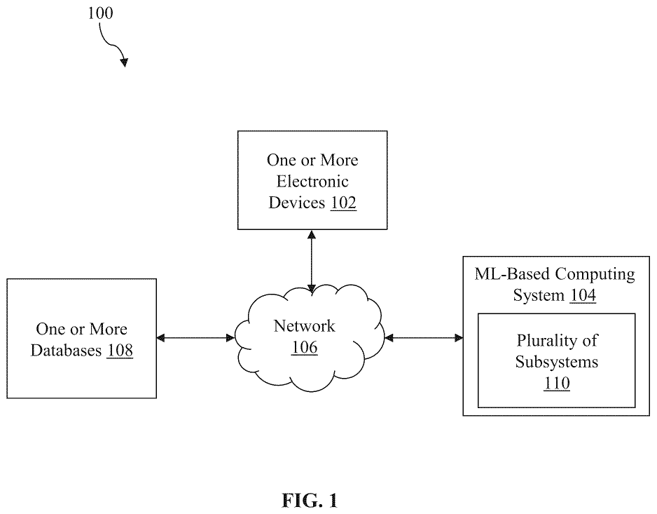

Referring now to the drawings, and more particularly to FIG. 1 through FIG. 6, where similar reference characters denote corresponding features consistently throughout the figures, there are shown preferred embodiments and these embodiments are described in the context of the following exemplary system and/or method.

FIG. 1 is a block diagram illustrating a computing environment 100 with a machine learning based (ML-based) computing system 104 for categorizing one or more electronic documents (example: one or more remittance documents) in one or more electronic mails, in accordance with an embodiment of the present disclosure. According to FIG. 1, the computing environment 100 includes one or more electronic devices 102 that are communicatively coupled to the ML-based computing system 104 through a network 106. The one or more electronic devices 102 through which one or more users provide one or more inputs to the ML-based computing system 104.

The present invention is configured to categorize the one or more remittance documents, including at least one of: invoices, payment confirmations, general communications, and the like, in the one or more electronic mails. The ML-based computing system 104 is initially configured to obtain data associated with the one or more electronic documents from one or more databases 108. In an embodiment, the data may be encrypted and decrypted by the ML-based computing system 104, so that one or more third party users cannot be authenticated to manipulate the data.

The ML-based computing system 104 is further configured to pre-process the data associated with the one or more electronic documents to generate the one or more pre-processed texts. In an embodiment, pre-processing the data may include at least one of: text extraction, sentence processing, and noise removal, from the one or more electronic documents. The ML-based computing system 104 is further configured to analyze the one or more one or more pre-processed texts associated with the one or more electronic documents to classify the one or more pre-processed texts into one of a finance related content and a non-finance related content, using a machine learning (ML) model.

The ML-based computing system 104 is further configured to categorize the one or more electronic documents as one of: one or more electronic financial documents when the one or more pre-processed texts are classified as the finance related content, using the ML model, and one or more electronic non-financial documents when the one or more pre-processed texts are classified as the non-finance related content, using the ML model.

The ML-based computing system 104 is further configured to re-categorize the categorized one or more electronic non-financial documents into the one or more electronic financial documents using a rule-based classification technique to mitigate false negative categorization of the one or more electronic documents as the one or more electronic non-financial documents. The ML-based computing system 104 is further configured to provide the categorized one or more electronic financial documents as an output, to one or more users on one or more user interfaces associated with the one or more electronic devices 102 associated with the one or more users.

In an embodiment, the one or more users may include at least one of: one or more customers, one or more organizations, one or more corporations, one or more parent companies, one or more subsidiaries, one or more joint ventures, one or more partnerships, one or more governmental bodies, one or more associations, and one or more legal entities, one or more data analysts, one or more business analysts, one or more cash analysts, one or more financial analysts, one or more collection analysts, one or more debt collectors, one or more professionals associated with cash and collection management, and the like.

The ML-based computing system 104 may be hosted on a central server including at least one of: a cloud server or a remote server. Further, the network 106 may be at least one of: a Wireless-Fidelity (Wi-Fi) connection, a hotspot connection, a Bluetooth connection, a local area network (LAN), a wide area network (WAN), any other wireless network, and the like. In an embodiment, the one or more electronic devices 102 may include at least one of: a laptop computer, a desktop computer, a tablet computer, a Smartphone, a wearable device, a Smart watch, and the like.

Further, the computing environment 100 includes the one or more databases 108 communicatively coupled to the ML-based computing system 104 through the network 106. In an embodiment, the one or more databases 108 includes at least one of: one or more relational databases, one or more object-oriented databases, one or more data warehouses, one or more cloud-based databases, and the like. In another embodiment, a format of the data obtained from the one or more databases 108 may include at least one of: a comma-separated values (CSV) format, a JavaScript Object Notation (JSON) format, an Extensible Markup Language (XML), spreadsheets, and the like.

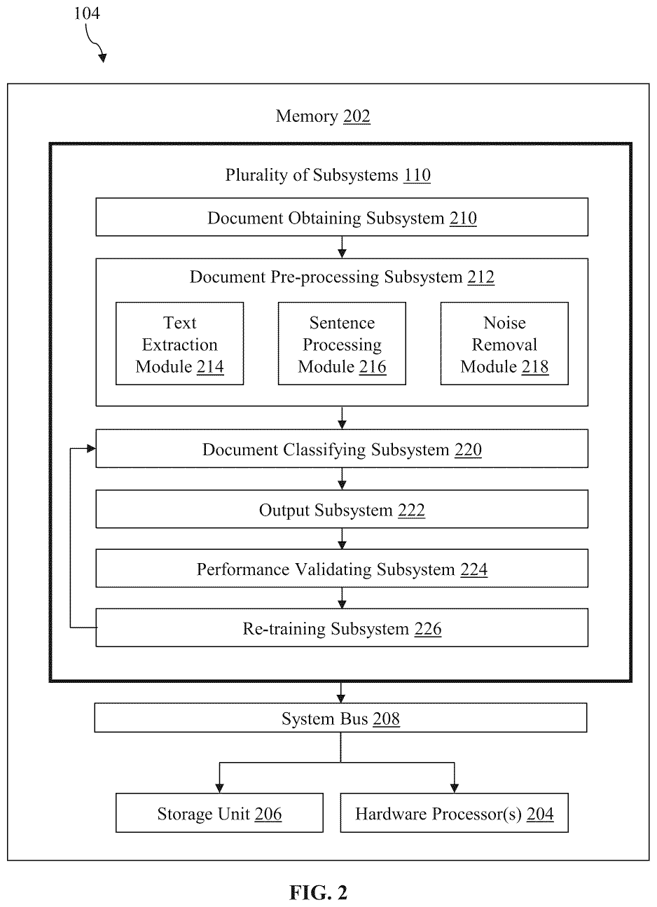

Furthermore, the one or more electronic devices 102 include at least one of: a local browser, a mobile application, and the like. Furthermore, the one or more users may use a web application through the local browser, the mobile application to communicate with the ML-based computing system 104. In an embodiment of the present disclosure, the ML-based computing system 104 includes a plurality of subsystems 110. Details on the plurality of subsystems 110 have been elaborated in subsequent paragraphs of the present description with reference to FIG. 2.

FIG. 2 is a detailed view of the ML-based computing system 104 for categorizing the one or more electronic documents in the one or more electronic mails, in accordance with another embodiment of the present disclosure. The ML-based computing system 104 includes a memory 202, one or more hardware processors 204, and a storage unit 206. The memory 202, the one or more hardware processors 204, and the storage unit 206 are communicatively coupled through a system bus 208 or any similar mechanism. The memory 202 includes the plurality of subsystems 110 in the form of programmable instructions executable by the one or more hardware processors 204.

The plurality of subsystems 110 includes a document obtaining subsystem 210, a document pre-processing subsystem 212, a document classifying subsystem 220, an output subsystem 222, a performance validating subsystem 224, and a re-training subsystem 226. The document pre-processing subsystem 212 includes a text extraction module 214, a sentence processing module 216, and a noise removal module 218. The brief details of the plurality of subsystems 110 have been elaborated in a below table.

| Plurality of | |
|---|---|
| Subsystems | |
| 110 | Functionality |
| Document | The document obtaining subsystem 210 is |
| obtaining | configured to obtain the data associated |
| subsystem 210 | with the one or more electronic documents |
| | from one or more databases 108. |
| Document pre- | The document pre-processing subsystem |
| processing | 212 is configured to pre-process the data |
| subsystem 212 | associated with the one or more electronic |
| | documents to generate the one or more |
| | pre-processed texts. The document |
| | pre-processing subsystem 212 includes a |
| | text extraction module 214 configured |
| | to extract one or more texts from one or |
| | more formats of the one or more electronic |
| | documents, using a document parser. |
| | The document pre-processing subsystem |
| | 212 further includes a sentence processing |
| | module 216 configured to perform sentence |
| | processing. The document pre-processing |
| | subsystem 212 further includes a noise |
| | removal module 218 configured to filter |
| | at least one of: one or more common |
| | language stop words, one or more non- |
| | alphabetic characters, and one or more |
| | special characters, from the one or more |
| | texts to generate the one or more |
| | pre-processed texts, based on one or |
| | more custom noise removal rules. |
| Document | The document classifying subsystem 220 |
| classifying | is configured to categorize the one or |
| subsystem 220 | more electronic documents as one of: |
| | when the one or more pre-processed texts |
| | are classified as the finance related |
| | content, using the ML model, and one or |
| | more electronic non-financial documents |
| | when the one or more pre-processed texts |
| | are classified as the non-finance related |
| | content, using the ML model. The document |
| | classifying subsystem 220 is further |
| | configured to re-categorize the categorized |
| | one or more electronic non-financial |
| | documents into the one or more electronic |
| | financial documents using a rule-based |
| | classification technique to mitigate false |
| | negative categorization of the one or more |
| | electronic documents as the one or more |
| | electronic non-financial documents. |
| Output | The output subsystem 222 is configured |
| subsystem 222 | to provide the categorized one or more |
| | electronic financial documents as the output, |
| | to one or more users on one or more user |
| | interfaces associated with the one or more |
| | electronic devices 102 associated with the |
| | one or more users. |
| Performance | The performance validating subsystem 224 is |
| validating | configured to validate performance of the |
| subsystem 224 | ML model based on the one or more testing |
| | datasets using a classification report. |
| Re-training | The re-training subsystem 226 is configured |
| subsystem 226 | to re-train the ML-model upon determining |
| | that the ML model needs to be optimized on |
| | categorization of the one or more electronic |
| | documents as one of the one or more electronic |
| | financial documents and the one or more |
| | electronic non-financial documents. |

The one or more hardware processors 204, as used herein, means any type of computational circuit, including, but not limited to, at least one of: a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, including at least one of: generic or programmable logic devices or arrays, application specific integrated circuits, single-chip computers, and the like.

The memory 202 may be non-transitory volatile memory and non-volatile memory. The memory 202 may be coupled for communication with the one or more hardware processors 204, being a computer-readable storage medium. The one or more hardware processors 204 may execute machine-readable instructions and/or source code stored in the memory 202. A variety of machine-readable instructions may be stored in and accessed from the memory 202. The memory 202 may include any suitable elements for storing data and machine-readable instructions, including at least one of: read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202 includes the plurality of subsystems 110 stored in the form of machine-readable instructions on any of the above-mentioned storage media and may be in communication with and executed by the one or more hardware processors 204.

The storage unit 206 may be a cloud storage, a Structured Query Language (SQL) data store, a noSQL database or a location on a file system directly accessible by the plurality of subsystems 110.

The plurality of subsystems 110 includes the document obtaining subsystem 210 that is communicatively connected to the one or more hardware processors 204. The document obtaining subsystem 210 is configured to obtain the data associated with the one or more electronic documents, from the one or more databases 108. In an embodiment, the one or more databases 108 may be one or more financial data repositories, which are integrated in the ML-based computing system 104. In an embodiment, the one or more electronic documents may be one or more financial documents (e.g., the one or more remittance documents) including at least one of: the invoices, the payment confirmations, the general communications, and the like.

In an embodiment, the one or more databases 108 may store the one or more electronic documents in one or more formats and languages, and the document obtaining subsystem 210 of the ML-based computing system 104 may be configured to automatically identify and extract the one or more relevant electronic documents. The document obtaining subsystem 210 may be configured to store the one or more electronic documents composed in any languages (e.g., English). The document obtaining subsystem 210 may be configured to retrieve the one or more electronic documents from one or more third-party databases through one or more application programming interfaces (APIs). The document obtaining subsystem 210 may be configured to support a range of APIs which may be used for retrieving the one or more financial documents in one or more formats.

The document obtaining subsystem 210 is configured to handle an input of the data associated with the one or more electronic documents. In an embodiment, the data associated with the one or more electronic documents may be in at least one of: a portable document format (PDF), an electronic mail format (EML), a text format, an image format, and the like. In an embodiment, the ML-based computing system 104 may be configured to provide feedback to the one or more users through the one or more electronic devices 102 if the one or more electronic documents are not in a format that may be handled by the ML-based computing system 104. In an embodiment, the document obtaining subsystem 210 is configured to authenticate the one or more users and to provide secure access to the one or more electronic documents.

The plurality of subsystems 110 further includes the document pre-processing subsystem 212 that is communicatively connected to the one or more hardware processors 204. The document pre-processing subsystem 212 is configured to pre-process the data associated with the one or more electronic documents to generate the one or more pre-processed texts. In an embodiment, pre-processing the data may include at least one of: text extraction, sentence processing, and noise removal, from the one or more electronic documents.

The document pre-processing subsystem 212 may include the text extraction module 214 configured to extract the one or more texts from the one or more formats of the one or more electronic documents, using the document parser. The text extraction module 214 is configured to obtain the one or more electronic documents as inputs. The text extraction module 214 is further configured to extract the one or more texts from the one or more formats (e.g., PDF, PNG, EML, and other formats including text-based and image-based documents) of the one or more electronic documents. The text extraction module 214 is further configured to utilize the document parser to interpret the PDF structure and to retrieve textual data effectively.

The text extraction module 214 is further configured to iteratively extract over each page of the electronic document, to process and aggregate the one or more texts from one or more lines. In an embodiment, when the electronic document in PDF format does not have the selectable text, the text extraction module 214 is configured to utilize Optical Character Recognition (OCR) engine as a fallback mechanism. The OCR engine may be used to determine a broader document coverage by extracting the one or more texts from embedded images whenever necessary. In an embodiment, the text extraction module 214 is further configured to manage one or more types of the one or more electronic documents. In an embodiment, the extracted one or more texts may be processed by tokenization that involves splitting of the one or more texts into individual words/tokens.

The tokenization process by a tokenizer may optimize the ability of the text extraction module 214 to manage one or more text formats and structures. In an embodiment, the text extraction module 214 is further configured to gracefully manage exceptions, providing informative error messages when the text extraction is unsuccessful. The error handling mechanism by the text extraction module 214 ensures reliability and facilitates troubleshooting. In an embodiment, the extracted information associated with the texts may be stored in a file with at least one of: Comma Separated Values (CSV) format, JavaScript Object Notation (JSON) format, and the like.

The document pre-processing subsystem 212 may further include the sentence processing module 216 configured to perform sentence processing. For sentence processing, the sentence processing module 216 is initially configured to obtain the extracted one or more texts from the one or more electronic documents to enhance the quality and simplification of the one or more texts, making the texts more optimized for analysis or for machine learning processes. The sentence processing module 216 is configured to split the one or more texts into one or more words to standardize the one or more texts for the ML model, using a tokenization process. The sentence processing module 216 is further configured to reduce the one or more words to a dictionary form of the one or more words using a lemmatization technique. The sentence processing module 216 is further configured to identify and categorize parts of speech of each of the one or more words with a predefined mapping to optimize word recognition. The sentence processing module 216 is further configured to determine and label one or more patterns associated with the one or more words, using a regular expression technique. In an embodiment, one or more patterns comprise at least one of: one or more alphabets, one or more numerical sequences, one or more dates, one or more monetary values, and one or more alphanumeric identifiers, within the one or more texts.

The sentence processing module 216 is further configured to identify potential identifiers associated with the finance related content using the one or more patterns, based on a length criteria. The overall sentence processing process is used to standardize and simplify the one or more texts, making the one or more texts more amenable to the machine learning model and natural language processing applications.

The document pre-processing subsystem 212 may further include the noise removal module 218 configured to obtain the processed one or more texts from the sentence processing module 216. The noise removal module 218 may include a rule engine configured to receive and store one or more custom noise removal rules pertaining to one or more financial documents. The noise removal module 218 configured to filter at least one of: one or more common language stop words, one or more non-alphabetic characters, and one or more recurring special characters, from the one or more texts to generate the one or more pre-processed texts, based on the one or more custom noise removal rules.

The plurality of subsystems 110 further includes the document classifying subsystem 220 that is communicatively connected to the one or more hardware processors 204. The document classifying subsystem 220 is configured to analyze the one or more pre-processed texts associated with the one or more electronic documents to classify the one or more pre-processed texts into one of a finance related content and a non-finance related content, using a machine learning (ML) model. The document classifying subsystem 220 is further configured to categorize the one or more electronic documents as one or more electronic financial documents when the one or more pre-processed texts are classified as the finance related content, using the ML model. The document classifying subsystem 220 is further configured to categorize the one or more electronic documents as one or more electronic non-financial documents when the one or more pre-processed texts are classified as the non-finance related content, using the ML model. In an embodiment, the document classifying subsystem 220 utilizes the ML model (e.g., a light gradient boosting machine (LGBM) model) that employs gradient boosting techniques to classify remittance-related content and the non-remittance related content, thereby enhancing the precision of financial document classification.

For analyzing the one or more pre-processed texts associated with the one or more electronic documents to classify the one or more pre-processed texts into one of the finance related content and the non-finance related content using the machine learning (ML) model, the document classifying subsystem 220 is configured to obtain at least one of: one or more training datasets and one or more testing datasets, associated with the one or more electronic documents from the one or more databases 108. The document classifying subsystem 220 is further configured to convert one or more labels (i.e., one or more categorical labels) associated with the one or more texts in the one or more training datasets and the one or more testing datasets, into one or more numerical formats for training the ML model, using a label encoding process.

The document classifying subsystem 220 is further configured to convert the one or more texts in the one or more training datasets and the one or more testing datasets, into the one or more numerical formats for training the ML model and classifying the one or more electronic documents, using term frequency-inverse document frequency (TFIDF) vectorizer. The document classifying subsystem 220 is further configured to select one or more features to represent the finance related content and the non-finance related content using the TFIDF vectorizer. The document classifying subsystem 220 is further configured to classify the one or more pre-processed texts into one of the finance related content and the non-finance related content using the ML model. The document classifying subsystem 220 is further configured to optimize the LGBM model to determine one or more hyperparameters from a predefined set of options, using a grid search technique. In an embodiment, the one or more hyperparameters are tuned using the grid search technique.

In an embodiment, the one or more hyperparameters may include at least one of: column sample by tree indicating proportion of columns randomly sampled for each tree. In an embodiment, the sampling of 80 percentage of the columns for each tree helps prevent overfitting and accelerates training. The one or more hyperparameters may further include learning rate indicating a rate at which the ML-model learns. In an embodiment, a learning rate of 0.1 strikes a good balance between performance and training speed, of the ML model. A smaller learning rate may improve performance but may require more boosting iterations and thus more training.

The one or more hyperparameters may further include optimum depth (i.e., maximum depth) indicating control of an optimum depth of each tree. The document classifying subsystem 220 may be configured to set the optimum depth to 2 to prevent the ML model from learning relations too specific to a particular sample, which may lead to overfitting. This means that the ML model uses relatively shallow trees, which helps the trees generalize better. The one or more hyperparameters may further include n estimators indicating a number of boosting iterations the ML-model executes. The number of boosting iterations is equivalent to a number of trees the document classifying subsystem 220 builds. The document classifying subsystem 220 sets the trees to 600, allowing the ML model to learn from 600 iterations. While multiple trees could potentially improve performance, a presence of a risk of overfitting is possible.

The one or more hyperparameters may further include a number of leaves indicating control of complexity of each tree of the ML model. The value needs to ideally be less than or equal to 2\hat{ }(max_depth) to prevent overfitting. The document classifying subsystem 220 is configured to set the trees to 100, meaning each tree in the ML model may have up to 100 leaves, which allows the ML model to learn multiple complex patterns.

The plurality of subsystems 110 further includes the performance validating subsystem 224 that is communicatively connected to the one or more hardware processors 204. Upon training, the performance validating subsystem 224 is configured to evaluate performance of the ML model using a classification report that includes at least one of: precision, recall, and F1-score metrics, for each class, as well as overall accuracy. In other words, the performance validating subsystem 224 is configured to validate performance of the ML model based on the one or more testing datasets using the classification report. In an embodiment, the classification report may provide an optimized level of accuracy indicating an optimized classification of the one or more electronic documents. The performance validating subsystem 224 is further configured to adjust the one or more hyperparameters to fine-tune the ML model based on one or more results of validation of the ML model.

The plurality of subsystems 110 further includes the re-training subsystem 226 that is communicatively connected to the one or more hardware processors 204. The re-training subsystem 226 is configured to obtain one or more assessments (e.g., one or more human assessments) of the ML model from the one or more users via the one or more electronic devices 102. In other words, the re-training subsystem 226 is configured to obtain the one or more human assessments on the ML model's predictions on a sample of data. Obtaining the one or more human assessments may involve having human evaluators review with a subset of predictions and providing their assessments (e.g., correct or incorrect). The re-training subsystem 226 is further configured to identify one or more differences between performance on the categorization of the one or more electronic documents by the ML model, and the one or more human assessments of the ML model obtained from the one or more users via the one or more electronic devices 102. The identification may help to analyze where the ML model needs to be improved.

The re-training subsystem 226 is further configured to determine whether the ML model needs to be optimized on categorization of the one or more electronic documents as one of the one or more electronic financial documents and the one or more electronic non-financial documents, based on the identified one or more differences between the performance on the categorization of the one or more electronic documents by the ML model, and the one or more assessments of the ML model obtained from the one or more users via the one or more electronic devices 102. The re-training subsystem 226 is further configured to utilize a feedback incorporation process for re-training the ML model upon determining that the ML model needs to be optimized on categorization of the one or more electronic documents as one of the one or more electronic financial documents and the one or more electronic non-financial documents. In an embodiment, re-training the ML model may include at least one of: updating pre-processing of the data associated with the one or more electronic documents, adjusting features selection criteria, adjusting the one or more hyperparameters, and the like.

The re-training subsystem 226 is further configured to monitor the performance of the ML model on categorization of the one or more electronic documents as one of the one or more electronic financial documents and the one or more electronic non-financial documents. The re-training subsystem 226 is further configured to collect the one or more assessments of the ML model over a plurality of time intervals. The re-training subsystem 226 is further configured to adapt the ML model to learn the one or more patterns in the data associated with the one or more electronic documents based on one or more feedback on the performance of the ML model.

In an embodiment, upon training the ML model, the ML model may be deployed to a cloud production environment. The cloud production environment may be any cloud computing platform, including at least one of: Amazon Web Services (AWS), Microsoft Azure, Google Cloud Platform (GCP), and the like. In an embodiment, the ML model may be deployed to the cloud production environment using any standard ML framework. For example, the ML model may be deployed using TensorFlow, PyTorch, scikit-learn, and the like.

The ML-based computing system 104 continuously monitors and adapts based on the feedback loop between the re-training subsystem 226 and the document classifying subsystem 220. The one or more feedback on the performance of the ML model and validation metrics inform the ML model updates. By iterating on the ML model performance either through user-guided adjustments or systematic re-training the ML model improves its precision and recall rates iteratively, achieving a higher level of accuracy over time. As part of the feedback loop, the ML-based computing system 104 initiates the re-training if performance assessment reveals a need for further optimization. This re-training incorporates adjustments in preprocessing (such as noise filtering or tokenization), feature selection criteria, and hyperparameter tuning, all to improve classification accuracy.

In an embodiment of the present disclosure, the document classifying subsystem 220 is configured to employ a robust rule-based classification technique to identify the one or more electronic non-financial documents (e.g., the non-remittance documents) as the one or more electronic financial documents with heightened precision.

For re-categorizing the categorized one or more electronic non-financial documents into the one or more electronic financial documents, the document classifying subsystem 220 is configured to obtain one or more information associated with the one or more electronic non-financial documents. The document classifying subsystem 220 is further configured to determine the false negative categorization of the one or more electronic documents as the one or more electronic non-financial documents. The document classifying subsystem 220 is further configured to identify one or more key elements (i.e., key patterns) associated with the one or more electronic non-financial documents to accurately re-categorize the one or more electronic non-financial documents as the one or more electronic financial documents. In an embodiment, the one or more key elements associated with the one or more electronic non-financial documents may include data associated with at least one of: date, amount, remittance identifier, and the like.

In an embodiment, the categorized one or more electronic financial documents may include the date indicating when a sender initiated the transfer of funds. The date serves as a record for when the transaction took place. The categorized one or more electronic financial documents may further include the remittance amount indicating a sum of money transferred to a receiver. The remittance amount is a principal value that the sender intends to transfer to the receiver. The categorized one or more electronic financial documents may further include the remittance identifier. The remittance identifier is a unique identifier assigned to each transaction. The remittance identifier helps in tracking and referencing the specific money transfer.

In order to re-categorize the categorized one or more electronic non-financial documents as the one or more electronic financial documents, the document classifying subsystem 220 is configured to utilize regular expressions capable of detecting the key patterns/elements within the one or more sentences. This approach ensures that the document classifying subsystem 220 captures the information, resulting in optimized accuracy. As a result, the one or more electronic non-financial documents meeting the pattern criteria may be accurately re-classified as the one or more electronic financial documents (i.e., the remittance documents). This precise identification allows for the accurate identification and correction of false negative in the remittance classification process.

In alternative embodiment of the present disclosure, the document classifying subsystem 220 re-categorizes the categorized one or more electronic financial documents into the one or more electronic non-financial documents, the document classifying subsystem 220 is configured to obtain one or more information associated with the one or more electronic financial documents to determine false positive categorization of the one or more electronic documents as the one or more electronic financial documents. The document classifying subsystem 220 is further configured to identify one or more key elements (i.e., key patterns) associated with the one or more electronic financial documents to accurately re-categorize the one or more electronic financial documents as the one or more electronic non-financial documents. In an embodiment, the one or more key elements associated with the one or more electronic financial documents may include data associated with at least one of: date, amount, remittance identifier, and the like.

In an alternative embodiment, the document classifying subsystem 220 applies a heuristic prediction and correction model to predict whether the categorization performed by the ML model results in false negative and/or false positive categorization and to perform correction by re-categorizing. Here, the heuristic prediction and correction model is applied when a prediction confidence of the ML model is less than a threshold value (Say 90%). To elaborate, the threshold value is used to determine in real-time whether the ML model is confident enough in its predictions, taking into account the different features and key elements (i.e., key patterns) in the one or more electronic documents. This helps in identifying false positive and/or false negative categorizations of the one or more electronic documents by the ML model.

The plurality of subsystems 110 further includes the output subsystem 222 that is communicatively connected to the one or more hardware processors 204. The output subsystem 222 is configured to provide the categorized one or more electronic financial documents as the output, to the one or more users on the one or more user interfaces of the one or more electronic devices 102 associated with the one or more users. In an embodiment, the output subsystem 222 is configured to integrate with a third-party database system, establishing a connection or utilizing appropriate APIs to facilitate data updates. The output subsystem 222 is further configured to support one or more database types, including at least one of: relational databases, NoSQL databases, document databases, or any other suitable database systems. The output subsystem 222 is further configured to efficiently update the one or more databases 108 with the extracted information, ensuring real-time synchronization and data consistency between the extracted data and a target database. The output subsystem 222 is further configured to provide one or more mechanisms for error handling, transaction management, and data logging, to maintain data integrity and traceability.

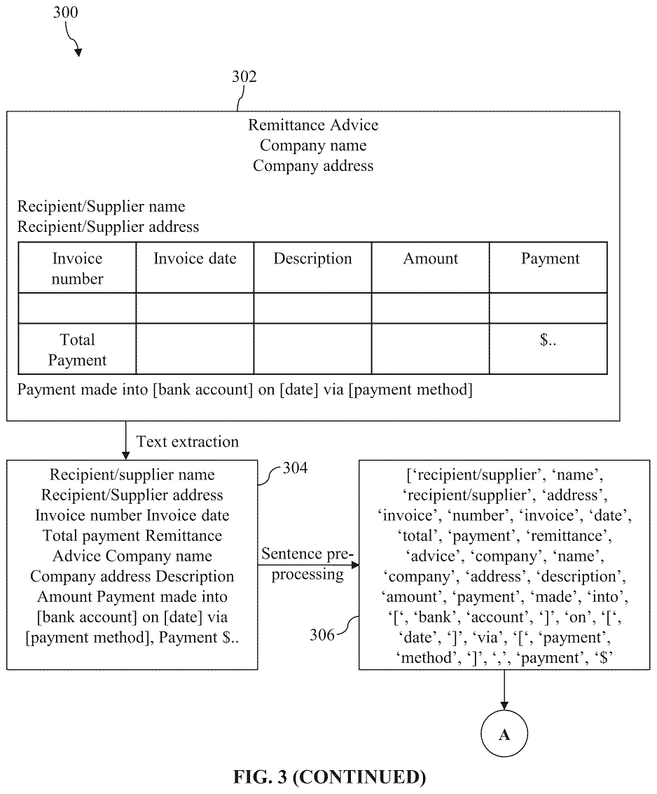

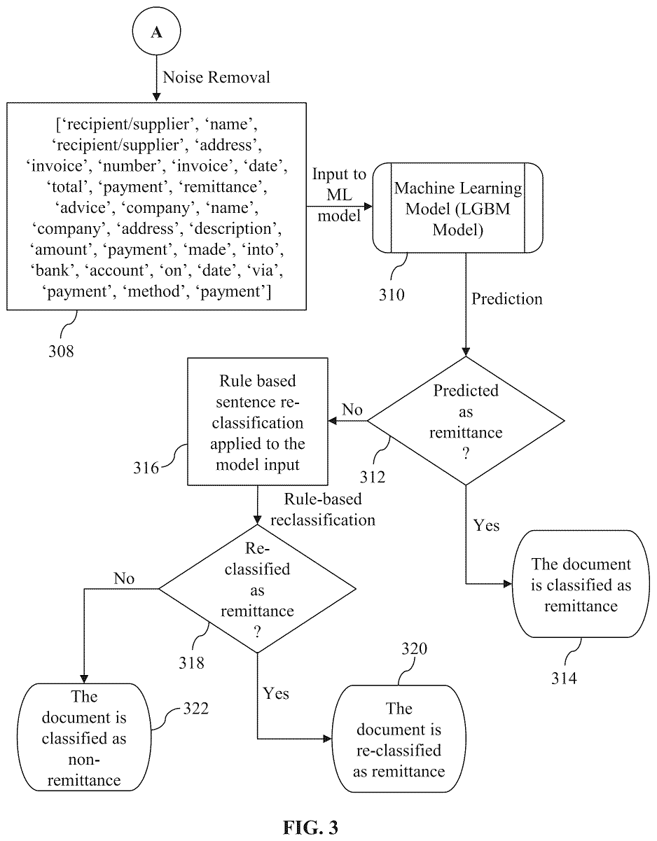

FIG. 3 is an overall process flow 300 of categorizing the one or more remittance documents in the one or more electronic mails, in accordance with another embodiment of the present disclosure. At step 302, the data associated with the one or more electronic documents, are obtained from the one or more databases 108. For example, FIG. 3 depicts that an electronic document shows contents including company name, company address, recipient name, recipient address, and the like. At step 304, the one or more texts including at least one of: company name, company address, recipient name, recipient address, and the like, are extracted from the electronic document, using the text extraction module 214. At step 306, the extracted one or more texts are processed identify the one or more words within the one or more electronic documents using the sentence processing module 216. At step 308, at least one of: the one or more common language stop words, the one or more non-alphabetic characters, and the one or more special characters, are filtered from the one or more texts to generate the pre-processed texts, based on the one or more custom noise removal rules, using the noise removal module 218.

The filtered texts are then inputted to the ML model as shown in step 310. At step 312, the ML model determines whether the electronic document is a remittance document based on the classification of the content (i.e., the finance related content and the non-finance related content) of the electronic document. If yes, the ML model categorizes that the electronic document is the remittance document when the pre-processed text is classified as the finance related content, as shown in 314. If no, the electronic document is predicted as “others” (i.e., electronic non-financial document) and the rule based re-classification technique is used to re-categorize the categorized electronic non-financial document into the electronic financial document to mitigate false negative categorization of the electronic documents as the electronic non-financial documents, as shown in step 316. At step 318, the rule based re-classification technique is configured to determine whether the electronic non-financial document is the remittance document by analyzing the key pattens in the electronic non-financial document. If yes, the electronic non-financial document is re-categorized as the remittance document from “others”, as shown in step 320. If no, the electronic non-financial document is categorized as a non-remittance document, as shown in step 322. In an embodiment, the predicted data associated with the electronic document is periodically updated in the one or more databases 108.

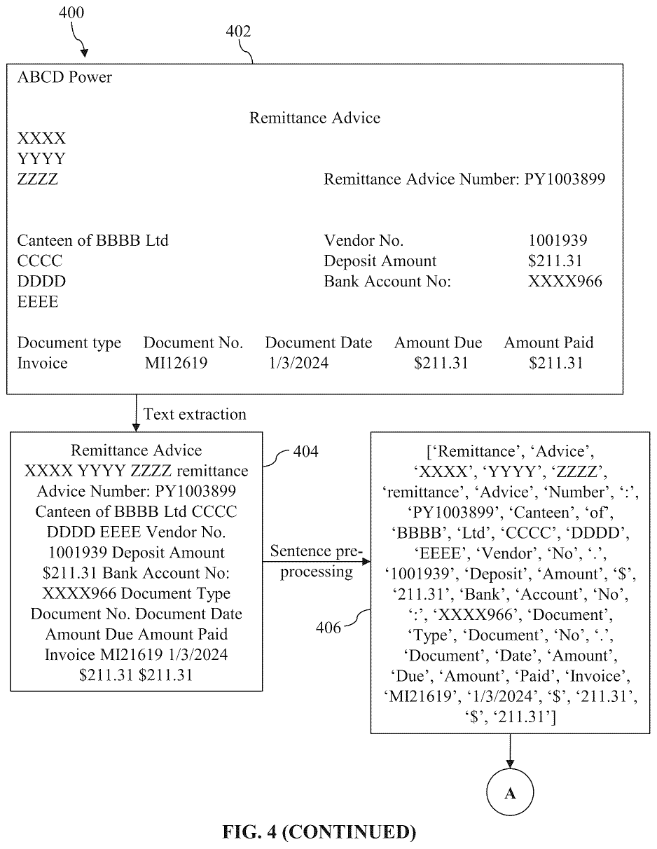

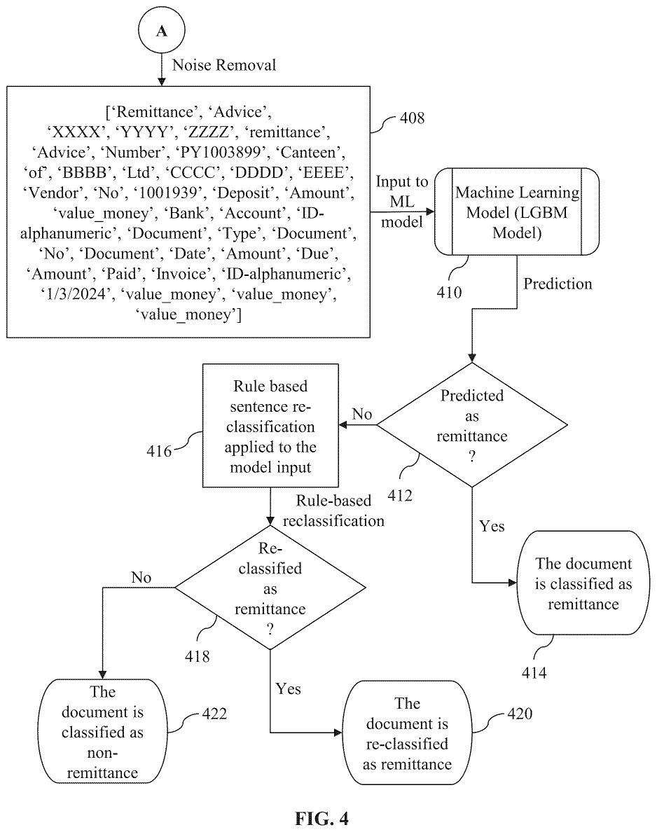

FIG. 4 is an exemplary process flow 400 of categorizing and re-categorizing the one or more remittance documents in the one or more electronic mails, in accordance with another embodiment of the present disclosure. At step 402, the data associated with the one or more electronic documents, are obtained from the one or more databases 108. For example, FIG. 4 depicts that an electronic document including company name (ABCD power), company address, remittance advice number, recipient name, recipient address, document type, document number, amount due, amount paid details, and the like, are obtained from the one or more databases 108. At step 404, the one or more texts including at least one of: company name (ABCD power), company address, remittance advice number, recipient name, recipient address, document type, document number, amount due, amount paid details, and the like, are extracted from the electronic document, using the text extraction module 214. At step 406, the extracted one or more texts are processed to identify the one or more words within the one or more electronic documents using the sentence processing module 216. At step 408, at least one of: the one or more common language stop words, the one or more non-alphabetic characters, and the one or more special characters, are filtered from the one or more texts to generate the pre-processed texts, based on the one or more custom noise removal rules, using the noise removal module 218.

The filtered texts are then inputted to the ML model as shown in step 410. At step 412, the ML model determines whether the electronic document is a remittance document based on the classification of the content (i.e., the finance related content and the non-finance related content) of the electronic document. If yes, the ML model categorizes that the electronic document is the remittance document when the pre-processed text is classified as the finance related content, as shown in 414.

If no, the electronic document is predicted as “others” (i.e., electronic non-financial document) and the rule based re-classification technique is used to re-categorize the categorized electronic non-financial document into the electronic financial document to mitigate false negative categorization of the electronic documents as the electronic non-financial documents, as shown in step 416. At step 418, the rule based re-classification technique is configured to determine whether the electronic non-financial document is the remittance document by analyzing the key patterns in the electronic non-financial document. If yes, the electronic non-financial document is re-categorized as the remittance document from “others”, as shown in step 420. If not, the electronic non-financial document is categorized as a non-remittance document, as shown in step 422. In an embodiment, the predicted data associated with the electronic document is periodically updated in the one or more databases 108.

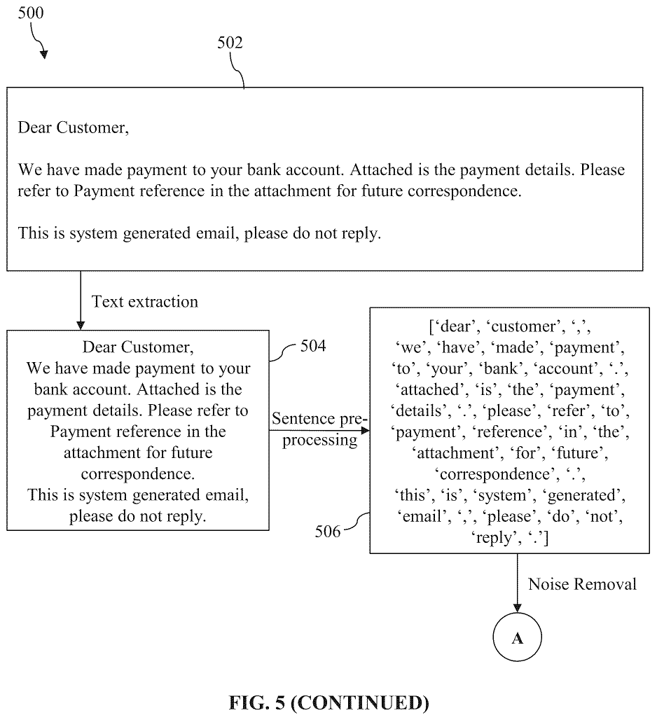

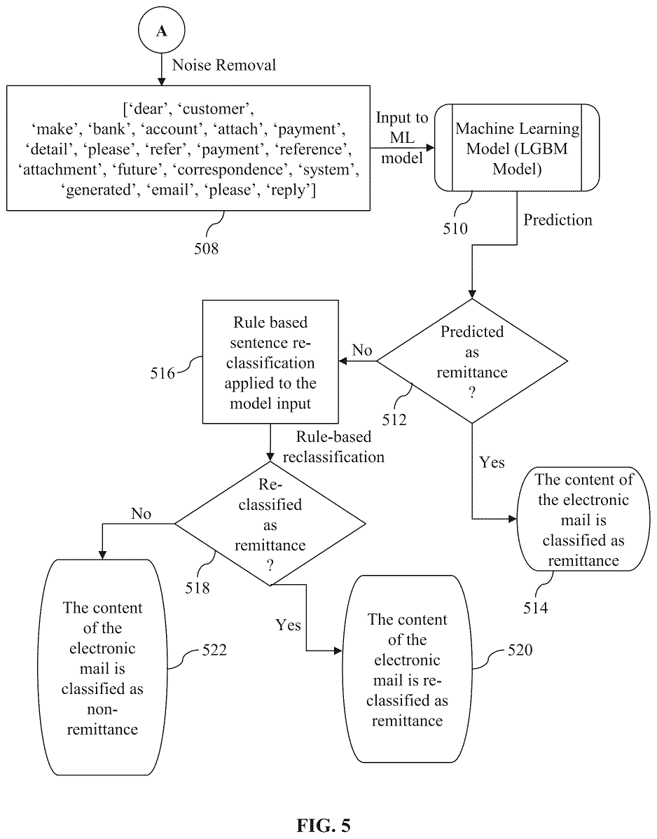

FIG. 5 is an exemplary process flow 500 of categorizing the content in the one or more electronic mails, in accordance with another embodiment of the present disclosure. At step 502, the data associated with the one or more electronic mails are obtained from the one or more databases 108. For example, the one or more electronic mails include a content of “We have made payment to your bank account. Attached is the payment details. Please refer to Payment reference in the attachment for future correspondence”. At step 504, the one or more texts given in the content, are extracted from the one or more electronic mails, using the text extraction module 214. At step 506, the extracted one or more texts are processed to identify the one or more words within the one or more electronic mails using the sentence processing module 216. At step 508, at least one of: the one or more common language stop words, the one or more non-alphabetic characters, and the one or more special characters, are filtered from the one or more texts to generate the pre-processed texts, based on the one or more custom noise removal rules, using the noise removal module 218.

The filtered texts are then inputted to the ML model as shown in step 510. At step 512, the ML model determines whether the content in the electronic mail is associated with a remittance document based on the classification of the content (i.e., the finance related content and the non-finance related content) of the electronic mail. If yes, the ML model categorizes that the content in the electronic mail is associated with the remittance document when the pre-processed text in the content is classified as the finance related content, as shown in 514. If no, the content in the electronic mail is predicted as “others” and the rule based re-classification technique is used to re-categorize the categorized non-finance related content in the electronic mail into the finance related content to mitigate false negative categorization of the content as the non-finance related content, as shown in step 516. At step 518, the rule based re-classification technique is configured to determine whether the non-finance related content in the electronic mail is associated with the remittance document by analyzing the key pattens in the non-finance related content in the electronic mail. If yes, the non-finance related content in the electronic mail is re-categorized as the content associated with the remittance document from “others”, as shown in step 520. If no, the non-finance related content in the electronic mail is categorized as a content associated with a non-remittance document, as shown in step 522. In an embodiment, the predicted data associated with the content is periodically updated in the one or more databases 108.

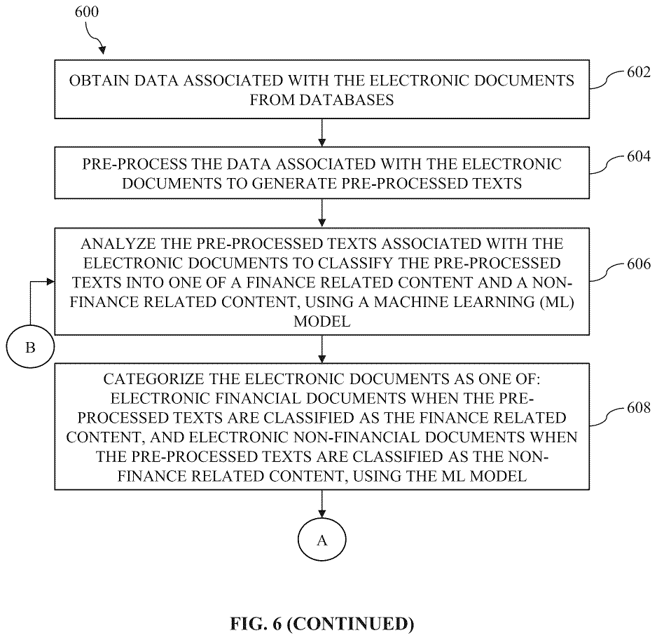

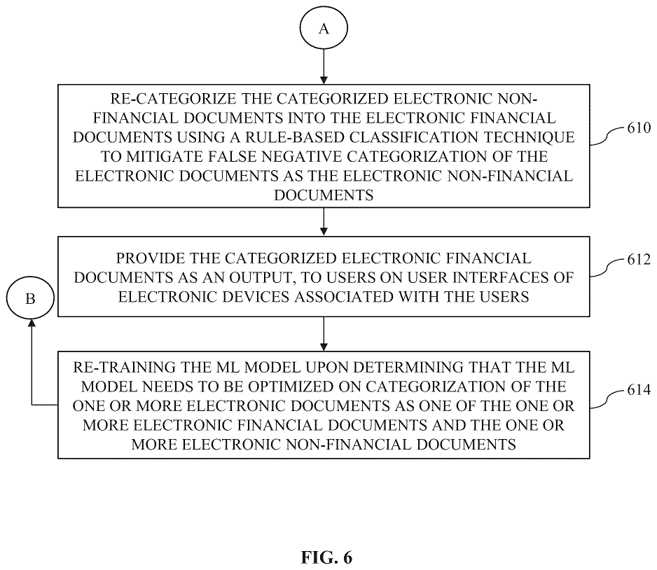

FIG. 6 is a flow chart illustrating a machine-learning based (ML-based) computing method 600 for categorizing the one or more remittance documents in the one or more electronic mails, in accordance with an embodiment of the present disclosure.

At step 602, the data associated with the one or more electronic documents are obtained from the one or more databases 108.

At step 604, the data associated with the one or more electronic documents are pre-processed to generate one or more pre-processed texts.

At step 606, the one or more pre-processed texts associated with the one or more electronic documents are analyzed to classify the one or more pre-processed texts into one of the finance related content and the non-finance related content, using the machine learning (ML) model.

At step 608, the one or more electronic documents are categorized as one of: the one or more electronic financial documents when the one or more pre-processed texts are classified as the finance related content, using the ML model, and the one or more electronic financial non-financial documents when the one or more pre-processed texts are classified as the non-finance related content, using the ML model.

At step 610, the categorized one or more electronic non-financial documents are re-categorized as the one or more electronic financial documents using the rule-based classification technique to mitigate the false negative categorization of the one or more electronic documents as the one or more electronic non-financial documents.

At step 612, the categorized one or more electronic financial documents is provided as the output, to the one or more users on the one or more user interfaces of the one or more electronic devices 102 associated with the one or more users.

At step 614, the ML model is re-trained upon determining that the ML model needs to be optimized on categorization of the one or more electronic documents as one of the one or more electronic financial documents and the one or more electronic non-financial documents. The ML model re-training comprises at least one of: updating pre-processing of the data associated with the one or more electronic documents, adjusting features selection criteria, and adjusting the one or more hyperparameters.

The present invention has the following advantages. The primary purpose of the present invention with the ML-based computing system 104 is to optimize the efficiency of processing the one or more electronic financial documents by automating the parsing and extracting processes using the ML model. The ML model aims to achieve accuracy in classifying the one or more electronic documents as one of: the one or more electronic financial documents (e.g., the one or more remittance documents) and others (e.g., the one or more non-remittance documents) while efficiently utilizing computing resources.

The ML-based computing system 104 and method 700 are configured to provide precise difference between the one or more remittance documents and the one or more non-remittance documents. The present invention with the ML-based computing system 104 is configured to classify/categorize the electronic documents as the electronic financial documents, in an automated manner so that the time consuming for categorizing the electronic financial documents is less than the manual process.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the ML-based computing system 104 either directly or through intervening I/O controllers. Network adapters may also be coupled to the ML-based computing system 104 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/ML-based computing system 104 in accordance with the embodiments herein. The ML-based computing system 104 herein comprises at least one processor or central processing unit (CPU). The CPUs are interconnected via the system bus 208 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the ML-based computing system 104. The ML-based computing system 104 can read the inventive instructions on the program storage devices and follow these instructions to execute the methodology of the embodiments herein.

The ML-based computing system 104 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

What is claimed is:

1. A machine-learning based (ML-based) computing method for automatically categorizing one or more electronic documents in one or more electronic mails, the ML-based computing method comprising:
obtaining, by one or more hardware processors, data associated with the one or more electronic documents from one or more databases;
pre-processing, by the one or more hardware processors, the data associated with the one or more electronic documents to generate one or more pre-processed texts;
analyzing, by the one or more hardware processors, the one or more pre-processed texts associated with the one or more electronic documents to classify the one or more pre-processed texts into one of a finance related content and a non-finance related content, using a machine learning (ML) model;
categorizing, by the one or more hardware processors, the one or more electronic documents as one of:
one or more electronic financial documents when the one or more pre-processed texts are classified as the finance related content, using the ML model, and
one or more electronic non-financial documents when the one or more pre-processed texts are classified as the non-finance related content, using the ML model;
re-categorizing, by the one or more hardware processors, the categorized one or more electronic non-financial documents into the one or more electronic financial documents using a rule-based classification technique to mitigate false negative categorization of the one or more electronic documents as the one or more electronic non-financial documents; and
providing, by the one or more hardware processors, the categorized one or more electronic financial documents as an output, to one or more users on one or more user interfaces associated with one or more electronic devices associated with the one or more users.

2. The machine-learning based (ML-based) computing method of claim 1, wherein pre-processing the data associated with the one or more electronic documents comprises extracting, by the one or more hardware processors, one or more texts from one or more formats of the one or more electronic documents, using a document parser.

3. The machine-learning based (ML-based) computing method of claim 2, wherein pre-processing the data associated with the one or more electronic documents further comprises sentence processing by:
splitting, by the one or more hardware processors, the one or more texts into one or more words to standardize the one or more texts for the ML model, using a tokenization process;
reducing, by the one or more hardware processors, the one or more words to a dictionary form of the one or more words using a lemmatization technique;
identifying, by the one or more hardware processors, parts of speech of each of the one or more words with a predefined mapping to optimize word recognition;
determining and labelling, by the one or more hardware processors, one or more patterns associated with the one or more words, using a regular expression technique, wherein the one or more patterns comprise at least one of: one or more alphabets, one or more numerical sequences, one or more dates, one or more monetary values, and one or more alphanumeric identifiers, within the one or more texts; and
identifying, by the one or more hardware processors, potential identifiers associated with the finance related content using the one or more patterns, based on a length criteria.

4. The machine-learning based (ML-based) computing method of claim 3, wherein pre-processing the data associated with the one or more electronic documents further comprises filtering, by the one or more hardware processors, at least one of: one or more common language stop words, one or more non-alphabetic characters, and one or more special characters, from the one or more texts to generate the one or more pre-processed texts, based on one or more custom noise removal rules.

5. The machine-learning based (ML-based) computing method of claim 1, wherein re-categorizing the categorized one or more electronic non-financial documents into the one or more electronic financial documents, comprises:
obtaining, by the one or more hardware processors, one or more information associated with the one or more electronic non-financial documents;
determining, by the one or more hardware processors, the one or more false negative categorization of the one or more electronic documents as the one or more electronic non-financial documents; and
identifying, by the one or more hardware processors, one or more key elements associated with the one or more electronic non-financial documents to accurately re-categorize the one or more electronic non-financial documents as the one or more electronic financial documents, wherein the one or more key elements associated with the one or more electronic non-financial documents comprise data associated with at least one of: date, amount, and remittance identifier.

6. The machine-learning based (ML-based) computing method of claim 3, wherein analyzing the one or more pre-processed texts associated with the one or more electronic documents to classify the one or more pre-processed texts into one of the finance related content and the non-finance related content using the machine learning (ML) model comprises:
obtaining, by the one or more hardware processors, at least one of: one or more training datasets and one or more testing datasets, associated with the one or more electronic documents from the one or more databases;
converting, by the one or more hardware processors, one or more labels associated with the one or more texts in the one or more training datasets and the one or more testing datasets, into one or more numerical formats for training the ML model, using a label encoding process;
converting, by the one or more hardware processors, the one or more texts in the one or more training datasets and the one or more testing datasets into the one or more numerical formats for training the ML model, using term frequency-inverse document frequency (TFIDF) vectorizer;
selecting, by the one or more hardware processors, one or more features to represent the finance related content and the non-finance related content using the TFIDF vectorizer;
classifying, by the one or more hardware processors, the one or more pre-processed texts into one of the finance related content and the non-finance related content using the ML model, wherein the ML model comprises a light gradient boosting machine (LGBM) model; and
optimizing, by the one or more hardware processors, the LGBM model to determine one or more hyperparameters from a predefined set of options, using a grid search technique,
wherein the one or more hyperparameters comprise at least one of: column sample by tree indicating proportion of columns randomly sampled for each tree, learning rate indicating a rate at which the ML-model learns, optimum depth indicating control of an optimum depth of each tree, n estimators indicating a number of boosting iterations the ML-model executes, number of leaves indicating control of complexity of each tree.

7. The machine-learning based (ML-based) computing method of claim 6, further comprising:
validating, by the one or more hardware processors, performance of the ML model based on the one or more testing datasets using a classification report, wherein the classification report comprises one or more metrics comprising at least one of: precision, recall, and F1-score metrics, and wherein the classification report provides an optimized level of accuracy indicating an optimized classification of the one or more electronic documents; and
adjusting, by the one or more hardware processors, the one or more hyperparameters to fine-tune the ML model based on one or more results of validation of the ML model.

8. The machine-learning based (ML-based) computing method of claim 7, further comprising re-training, by the one or more hardware processors, the ML model, wherein re-training the ML model comprises:
obtaining, by the one or more hardware processors, one or more assessments of the ML model from the one or more users via the one or more electronic devices;
identifying, by the one or more hardware processors, one or more differences between performance on the categorization of the one or more electronic documents by the ML model, and the one or more assessments of the ML model obtained from the one or more users via the one or more electronic devices;
determining, by the one or more hardware processors, whether the ML model needs to be optimized on categorization of the one or more electronic documents as one of the one or more electronic financial documents and the one or more electronic non-financial documents, based on the identified one or more differences between the performance on the categorization of the one or more electronic documents by the ML model, and the one or more assessments of the ML model obtained from the one or more users via the one or more electronic devices;
re-training, by the one or more hardware processors, the ML model upon determining that the ML model needs to be optimized on categorization of the one or more electronic documents as one of the one or more electronic financial documents and the one or more electronic non-financial documents,
wherein re-training the ML model comprises at least one of: updating pre-processing of the data associated with the one or more electronic documents, adjusting features selection criteria, and adjusting the one or more hyperparameters;
monitoring, by the one or more hardware processors, the performance of the ML model on categorization of the one or more electronic documents as one of the one or more electronic financial documents and the one or more electronic non-financial documents;
collecting, by the one or more hardware processors, the one or more assessments of the ML model over a plurality of time intervals; and
adapting, by the one or more hardware processors, the ML model to learn the one or more patterns in the data associated with the one or more electronic documents based on one or more feedback on the performance of the ML model.

9. A machine learning based (ML-based) computing system for automatically categorizing one or more electronic documents in one or more electronic mails, the ML-based computing system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
a document obtaining subsystem configured to obtain data associated with the one or more electronic documents from one or more databases;
a document pre-processing subsystem configured to pre-process the data associated with the one or more electronic documents to generate one or more pre-processed texts;
a document classifying subsystem configured to:
analyze the one or more pre-processed texts associated with the one or more electronic documents to classify the one or more pre-processed texts into one of a finance related content and a non-finance related content, using a machine learning (ML) model;
categorize the one or more electronic documents as one of:
one or more electronic financial documents when the one or more pre-processed texts are classified as the finance related content, using the ML model, and
one or more electronic non-financial documents when the one or more pre-processed texts are classified as the non-finance related content, using the ML model;
re-categorize the categorized one or more electronic non-financial documents into the one or more electronic financial documents using a rule based classification technique to mitigate false negative categorization of the one or more electronic documents as the one or more electronic non-financial documents; and
an output subsystem configured to provide the categorized one or more electronic financial documents as an output, to one or more users on one or more user interfaces associated with one or more electronic devices associated with the one or more users.

10. The machine-learning based (ML-based) computing system of claim 9, wherein in pre-processing the data associated with the one or more electronic documents, the document pre-processing subsystem is configured to extract one or more texts from one or more formats of the one or more electronic documents, using a text extraction module with a document parser.

11. The machine-learning based (ML-based) computing system of claim 10, wherein in pre-processing the data associated with the one or more electronic documents, the document pre-processing subsystem is further configured to perform sentence processing by:
splitting the one or more texts into one or more words to standardize the one or more texts for the ML model, using a tokenization process;
reducing the one or more words to a dictionary form of the one or more words using a lemmatization technique;
identifying parts of speech of each of the one or more words with a predefined mapping to optimize word recognition;
determining and labelling one or more patterns associated with the one or more words, using a regular expression technique, wherein the one or more patterns comprise at least one of: one or more alphabets, one or more numerical sequences, one or more dates, one or more monetary values, and one or more alphanumeric identifiers, within the one or more texts; and
identifying potential identifiers associated with the finance related content using the one or more patterns, based on a length criteria.

12. The machine-learning based (ML-based) computing system of claim 11, wherein in pre-processing the data associated with the one or more electronic documents, the document pre-processing subsystem is further configured to filter at least one of: one or more common language stop words, one or more non-alphabetic characters, and one or more special characters, from the one or more texts to generate the one or more pre-processed texts, based on one or more custom noise removal rules using a noise removal module.

13. The machine-learning based (ML-based) computing system of claim 9, wherein in re-categorizing the categorized one or more electronic non-financial documents into the one or more electronic financial documents, the document classifying subsystem is configured to:
obtain one or more information associated with the one or more electronic non-financial documents;
determine the false negative categorization of the one or more electronic documents as the one or more electronic non-financial documents; and
identify one or more key elements associated with the one or more electronic non-financial documents to accurately re-categorize the one or more electronic non-financial documents as the one or more electronic financial documents, wherein the one or more key elements associated with the one or more electronic non-financial documents comprise data associated with at least one of: date, amount, and remittance identifier.

14. The machine-learning based (ML-based) computing system of claim 11, wherein in analyzing the one or more pre-processed texts associated with the one or more electronic documents to classify the one or more pre-processed texts into one of the finance related content and the non-finance related content using the machine learning (ML) model, the document classifying subsystem is configured to:
obtain at least one of: one or more training datasets and one or more testing datasets, associated with the one or more electronic documents from the one or more databases;
convert one or more labels associated with the one or more texts in the one or more training datasets and the one or more testing datasets, into one or more numerical formats for training the ML model, using a label encoding process;
convert the one or more texts in the one or more training datasets and the one or more testing datasets, into the one or more numerical formats for training the ML model, using term frequency-inverse document frequency (TFIDF) vectorizer;
select one or more features to represent the finance related content and the non-finance related content using the TFIDF vectorizer;
classify the one or more pre-processed texts into one of the finance related content and the non-finance related content using the ML model, wherein the ML model comprises a light gradient boosting machine (LGBM) model;
optimize the LGBM model to determine one or more hyperparameters from a predefined set of options, using a grid search technique,
wherein the one or more hyperparameters comprise at least one of: column sample by tree indicating proportion of columns randomly sampled for each tree, learning rate indicating a rate at which the ML-model learns, optimum depth indicating control of an optimum depth of each tree, n estimators indicating a number of boosting iterations the ML-model executes, number of leaves indicating control of complexity of each tree.

15. The machine-learning based (ML-based) computing system of claim 14, further comprising a performance validating subsystem configured to:
validate performance of the ML model based on the one or more testing datasets using a classification report, wherein the classification report comprises one or more metrics comprising at least one of: precision, recall, and F1-score metrics, and wherein the classification report provides an optimized level of accuracy indicating an optimized classification of the one or more electronic documents; and
adjust the one or more hyperparameters to fine-tune the ML model based on one or more results of validation of the ML model.

16. The machine-learning based (ML-based) computing system of claim 15, further comprising a re-training subsystem configured to:
obtain one or more assessments of the ML model from the one or more users via the electronic devices;
identify one or more differences between performance on the categorization of the one or more electronic documents by the ML model, and the one or more assessments of the ML model obtained from the one or more users via the one or more electronic devices;
determine whether the ML model needs to be optimized on categorization of the one or more electronic documents as one of the one or more electronic financial documents and the one or more electronic non-financial documents, based on the identified one or more differences between the performance on the categorization of the one or more electronic documents by the ML model, and the one or more assessments of the ML model obtained from the one or more users via the one or more electronic devices;
re-train the ML model upon determining that the ML model needs to be optimized on categorization of the one or more electronic documents as one of the one or more electronic financial documents and the one or more electronic non-financial documents,
wherein re-training the ML model comprises at least one of: updating pre-processing of the data associated with the one or more electronic documents, adjusting features selection criteria, and adjusting the one or more hyperparameters;
monitor the performance of the ML model on categorization of the one or more electronic documents as one of the one or more electronic financial documents and the one or more electronic non-financial documents;
collect the one or more assessments of the ML model over a plurality of time intervals; and
adapt the ML model to learn the one or more patterns in the data associated with the one or more electronic documents based on one or more feedback on the performance of the ML model.

17. A non-transitory computer-readable storage medium having instructions stored therein that when executed by one or more hardware processors, cause the one or more hardware processors to execute operations of:
obtaining data associated with the one or more electronic documents from one or more databases;
pre-processing the data associated with the one or more electronic documents to generate one or more pre-processed texts;
analyzing the one or more pre-processed texts associated with the one or more electronic documents to classify the one or more pre-processed texts into one of a finance related content and a non-finance related content, using a machine learning (ML) model;
categorizing the one or more electronic documents as one of:
one or more electronic financial documents when the one or more pre-processed texts are classified as the finance related content, using the ML model, and
one or more electronic non-financial documents when the one or more pre-processed texts are classified as the non-finance related content, using the ML model;
re-categorizing the categorized one or more electronic non-financial documents into the one or more electronic financial documents using a rule based classification technique to mitigate false negative categorization of the one or more electronic documents as the one or more electronic non-financial documents; and
providing the categorized one or more electronic financial documents as an output, to one or more users on one or more user interfaces associated with one or more electronic devices associated with the one or more users.

18. The non-transitory computer-readable storage medium of claim 17, wherein re-categorizing the categorized one or more electronic non-financial documents into the one or more electronic financial documents, comprises:
obtaining one or more information associated with the one or more electronic non-financial documents;
determining the one or more false negative categorization of the one or more electronic documents as the one or more electronic non-financial documents; and
identifying one or more key elements associated with the one or more electronic non-financial documents to accurately re-categorize the one or more electronic non-financial documents as the one or more electronic financial documents, wherein the one or more key elements associated with the one or more electronic non-financial documents comprise data associated with at least one of: date, amount, and remittance identifier.

19. The non-transitory computer-readable storage medium of claim 17, wherein analyzing the one or more pre-processed texts associated with the one or more electronic documents to classify the one or more pre-processed texts into one of the finance related content and the non-finance related content using the machine learning (ML) model comprises:
obtaining at least one of: one or more training datasets and one or more testing datasets, associated with the one or more electronic documents from the one or more databases;
converting one or more labels associated with the one or more texts in the one or more training datasets and the one or more testing datasets, into one or more numerical formats for training the ML model, using a label encoding process;
converting the one or more texts in the one or more training datasets and the one or more testing datasets into the one or more numerical formats for training the ML model, using term frequency-inverse document frequency (TFIDF) vectorizer;
selecting one or more features to represent the finance related content and the non-finance related content using the TFIDF vectorizer;
classifying the one or more pre-processed texts into one of the finance related content and the non-finance related content using the ML model, wherein the ML model comprises a light gradient boosting machine (LGBM) model;
optimizing the LGBM model to determine one or more hyperparameters from a predefined set of options, using a grid search technique,
wherein the one or more hyperparameters comprise at least one of: column sample by tree indicating proportion of columns randomly sampled for each tree, learning rate indicating a rate at which the ML-model learns, optimum depth indicating control of an optimum depth of each tree, n estimators indicating a number of boosting iterations the ML-model executes, number of leaves indicating control of complexity of each tree.

20. The non-transitory computer-readable storage medium of claim 19, further comprising:
validating performance of the ML model based on the one or more testing datasets using a classification report, wherein the classification report comprises one or more metrics comprising at least one of: precision, recall, and F1-score metrics, and wherein the classification report provides an optimized level of accuracy indicating an optimized classification of the one or more electronic documents;
adjusting the one or more hyperparameters to fine-tune the ML model based on one or more results of validation of the ML model; and
re-training the ML model, wherein re-training the ML model comprises:
obtaining one or more assessments of the ML model from the one or more users via the one or more electronic devices;
identifying one or more differences between performance on the categorization of the one or more electronic documents by the ML model, and the one or more assessments of the ML model obtained from the one or more users via the one or more electronic devices;
determining whether the ML model needs to be optimized on categorization of the one or more electronic documents as one of the one or more electronic financial documents and the one or more electronic non-financial documents, based on the identified one or more differences between the performance on the categorization of the one or more electronic documents by the ML model, and the one or more assessments of the ML model obtained from the one or more users via the one or more electronic devices;
re-training the ML model upon determining that the ML model needs to be optimized on categorization of the one or more electronic documents as one of the one or more electronic financial documents and the one or more electronic non-financial documents,
wherein re-training the ML model comprises at least one of: updating pre-processing of the data associated with the one or more electronic documents, adjusting features selection criteria, and adjusting the one or more hyperparameters;
monitoring the performance of the ML model on categorization of the one or more electronic documents as one of the one or more electronic financial documents and the one or more electronic non-financial documents;
collecting the one or more assessments of the ML model over a plurality of time intervals; and
adapting the ML model to learn the one or more patterns in the data associated with the one or more electronic documents based on one or more feedback on the performance of the ML model.
